(19) United States
(12) Patent Application Publication
(10) Pub. No.: US 2025/0103890 A1
(43) Pub. Date: Mar. 27, 2025

(54) UNSUPERVISED PROMPT LEARNING FOR DATA PRE-SELECTION WITH VISION-LANGUAGE MODELS

(71) Applicant: Robert Bosch GmbH, Stuttgart (DE)

(72) Inventors: XIN LI, Sunnyvale, CA (US); SIMA BEHPOUR, Sunnyvale, CA (US); THANG DOAN, San Francisco, CA (US); WENBIN HE, Sunnyvale, CA (US); LIANG GOU, San Jose, CA (US); LIU REN, Saratoga, CA (US)

(21) Appl. No.: 18/372,532

(22) Filed: Sep. 25, 2023

(51) Int. Cl. G06N 3/088; G06F 40/40; G06V 10/44; G06V 10/762; G06V 10/774; G06V 10/776; G06V 20/70

(52) U.S. Cl. CPC G06N 3/088; G06F 40/40; G06V 10/44; G06V 10/762; G06V 10/7753; G06V 10/776; G06V 20/70

(57) ABSTRACT

A method of performing data pre-selection for an object detection system includes receiving a first dataset that includes unlabeled data corresponding to one or more images, providing the first dataset and a plurality of learnable prompt vectors to a pre-training model. The learnable prompt vectors include text inputs. The method further includes generating, using the pre-training model, an unsupervised learning prompt based on the first dataset and the plurality of learnable prompt vectors. The unsupervised learning prompt corresponds to a multi-modal feature of the one or more images of the first dataset. The method further includes extracting features from either of the first dataset and a second dataset based on the unsupervised learning prompt, selecting and labeling a subset of instances of the extracted features, and generating and outputting a labeled dataset based on the labeled subset of instances.

### TECHNICAL FIELD

The present disclosure relates to data pre-selection for object detection systems and methods.

### BACKGROUND

Object detection techniques such as visual object detection techniques may use various detection models to detect or predict, classify, and label objects and regions in captured images. For example, one or more machine learning models are trained for object detection and labeling using subsets of data samples.

### SUMMARY

A method of performing data pre-selection for an object detection system includes receiving a first dataset that includes unlabeled data corresponding to one or more images, providing the first dataset and a plurality of learnable prompt vectors to a pre-training model. The learnable prompt vectors include text inputs. The method further includes generating, using the pre-training model, an unsupervised learning prompt based on the first dataset and the plurality of learnable prompt vectors. The unsupervised learning prompt corresponds to a multi-modal feature of the one or more images of the first dataset. The method further includes extracting features from either of the first dataset and a second dataset based on the unsupervised learning prompt, selecting and labeling a subset of instances of the extracted features, and generating and outputting a labeled dataset based on the labeled subset of instances.

In other features, the pre-training model is a Bootstrapping Language-Image Pre-training (BLIP-2) model. The extracted features include clusters of unlabeled image data. The selected subset of instances includes one or more of the clusters of unlabeled data. The method further includes selecting a representative image for labeling from each of the clusters of unlabeled image data. Selecting the representative image includes selecting the representative image based on a medoid of a corresponding one of the clusters of unlabeled image data. Generating the unsupervised learning prompt includes calculating instance-level contrastive loss and cluster-level contrastive loss.

A computing device configured to perform data pre-selection for an object detection system includes a processing device configured to execute instructions stored in memory to receive a first dataset that includes unlabeled data corresponding to one or more images and provide the first dataset and a plurality of learnable prompt vectors to a pre-training model. The learnable prompt vectors include text inputs. The processing device is further configured to execute instructions to generate, using the pre-training model, an unsupervised learning prompt based on the first dataset and the plurality of learnable prompt vectors, the unsupervised learning prompt corresponding to a multi-modal feature of the one or more images of the first dataset, extract features from either of the first dataset and a second dataset based on the unsupervised learning prompt, select and label a subset of instances of the extracted features, and generate and output a labeled dataset based on the labeled subset of instances.

In other features, the pre-training model is a Bootstrapping Language-Image Pre-training (BLIP-2) model. The extracted features include clusters of unlabeled image data. The selected subset of instances includes one or more of the clusters of unlabeled data. The processing device is configured to execute instructions to select a representative image for labeling from each of the clusters of unlabeled image data. The processing device is configured to execute instructions to select the representative image based on a medoid of a corresponding one of the clusters of unlabeled image data. The processing device is configured to execute instructions to calculate instance-level contrastive loss and cluster-level contrastive loss.

A computer-controlled machine includes at least one sensor configured to generate an input image, a control system configured to perform data pre-selection for an object detection system, the control system configured to receive a first dataset that includes unlabeled data corresponding to one or more images, provide the first dataset and a plurality of learnable prompt vectors that include text inputs to a pre-training model, generate, using the pre-training model and based on the first dataset and the plurality of learnable prompt vectors, an unsupervised learning prompt that corresponds to a multi-modal feature of the one or more images of the first dataset, extract features from either of the first dataset and a second dataset based on the unsupervised learning prompt, select and label a subset of instances of the extracted features, and generate and output a labeled dataset based on the labeled subset of instances, and an actuator configured to control an operation of the computer-controlled machine based on the labeled dataset.

In other features, the pre-training model is a Bootstrapping Language-Image Pre-training (BLIP-2) model. The extracted features include clusters of unlabeled image data, and wherein the selected subset of instances includes one or more of the clusters of unlabeled data. The control system is configured to select a representative image for labeling from each of the clusters of unlabeled image data. The control system is configured to select the representative image based on a medoid of a corresponding one of the clusters of unlabeled image data. The control system is configured to calculate instance-level contrastive loss and cluster-level contrastive loss.

### BRIEF DESCRIPTION OF THE DRAWINGS

FIG. 1 generally illustrates a system for training a neural network according to the principles of the present disclosure.

FIG. 2 generally illustrates a computer-implemented method for training and utilizing a neural network according the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIG. 4A generally illustrates an example data pre-selection system according to the present disclosure.

FIG. 4B generally illustrates data pre-selection according to systems and methods of the present disclosure.

FIG. 4C generally illustrates results of unsupervised prompt learning for data pre-selection (UP-DP) systems and methods of the present disclosure for downstream tasks.

FIG. 4D illustrates steps of an example data pre-selection method according to the principles of the present disclosure.

FIG. 5 depicts a schematic diagram of an interaction between a computer-controlled machine and a control system according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Vision language machine learning models for object detection systems and methods are trained using subsets of data samples. Data-efficient machine learning, which aims to identify the best subsets of data samples (to either label or not) in order to achieve optimal model performance, has been a crucial research field in the era of data-hungry deep learning.

Semi-supervised learning (SSL) and Active Learning (AL) are two example approaches for improving data efficiency learning. SSL aims to address the problem of label scarcity by leveraging a limited quantity of labeled data in conjunction with a more abundant pool of unlabeled data to enhance the model's performance. By contrast, AL approaches start with an initial set of labeled data and select the most informative data point to label to maximize model performance with a limited label budget. However, existing AL methods need an initial labeled set to begin with and need to train a series of models.

Accordingly, the task of data pre-selection poses some challenges that SSL and AL fail to adequately address. In data pre-selection, initial data is unlabeled and specific downstream tasks are unknown. For example, with object detection, the categories of objects that need to be detected are unknown. However, SSL and AL methods required both initial labeled data and knowledge of specific learning tasks. Therefore, a method to select diverse and representative instances is required to cover the entire dataset with a minimum number of required labels.

In some examples, foundational Vision-Language (V-L) models, such as Contrastive Language-Image Pre-training (CLIP) models and Bootstrapping Language-Image Pre-training (BLIP-2) models, may address some problems associated with SSL and AL methods. These V-L models acquire comprehensive semantic knowledge by learning from a vast collection of image and text pairs. Consequently, V-L models may have the ability to extract meaningful features from diverse input modalities. While V-L models can be adapted for various tasks like few-shot classification, semi-supervised learning, and selective labeling, such models may place emphasis on unimodal features (e.g., vision) and inadvertently overlook potential contributions of multi-modal features encompassing both vision and language.

Designing an appropriate prompt for V-L models can be demanding and time-consuming, often requiring trial and error. Moreover, various automatic prompt learning approaches typically rely on a small set of labeled or pseudo labeled data, which is impractical for data pre-selection when the downstream tasks are undefined.

Data pre-selection systems and methods according to the present disclosure incorporate unsupervised prompt learning in a vision-language model for data pre-selection. More specifically, systems and methods described herein implement prompt learning techniques configured to select instances for labeling from an unlabeled dataset through a single pass, thereby optimizing performance for undefined downstream tasks with a limited annotation budget. Previous approaches to data pre-selection relied solely on visual features extracted from foundation models (e.g., CLIP and BLIP-2 models as described above) but largely ignored the importance of text features. Pure unsupervised prompt learning according to the present disclosure aim to enhance the multi-modal features extracted from V-L models for data pre-selection.

As described herein, the prompt may be designed such that the multi-modal features extracted by V-L models provide a more powerful representation for data pre-selection. The joint feature space of both vision and text can yield a better representation for data pre-selection. Unsupervised prompt learning for data pre-selection (“UP-DP”) according to the present disclosure implements an unsupervised prompt learning approach that adapts vision-language pre-training models (e.g., BLIP-2) models for data pre-selection. Specifically, with BLIP-2 parameters fixed or frozen, text prompts are trained to extract the joint features with improved representation, ensuring a diverse cluster structure that covers the entire dataset. The prompts learned from one example dataset demonstrate significant generalizability and can be directly applied to enhance the feature extraction of BLIP-2 models from other datasets.

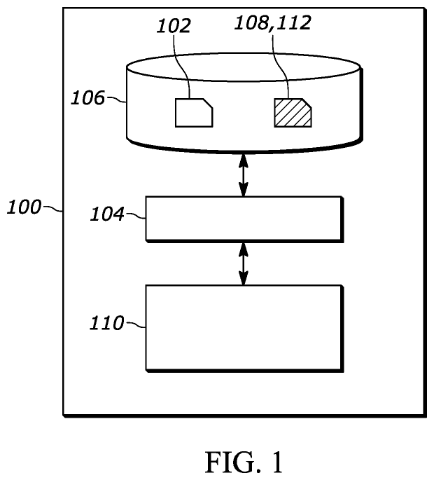

FIG. 1 shows one example system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network. This data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

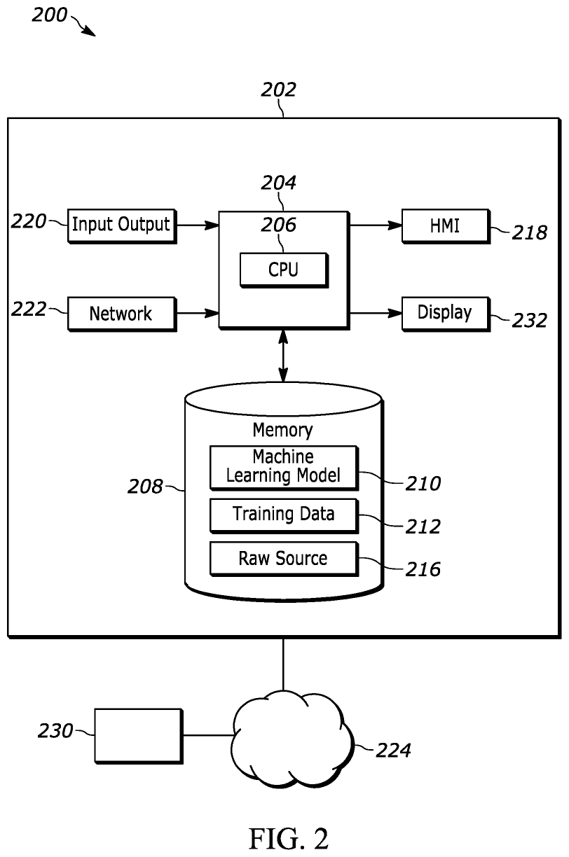

FIG. 2 depicts a data annotation/augmentation system 200 configured to (and/or including circuitry configured to) implement a system for annotating and/or augmenting data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

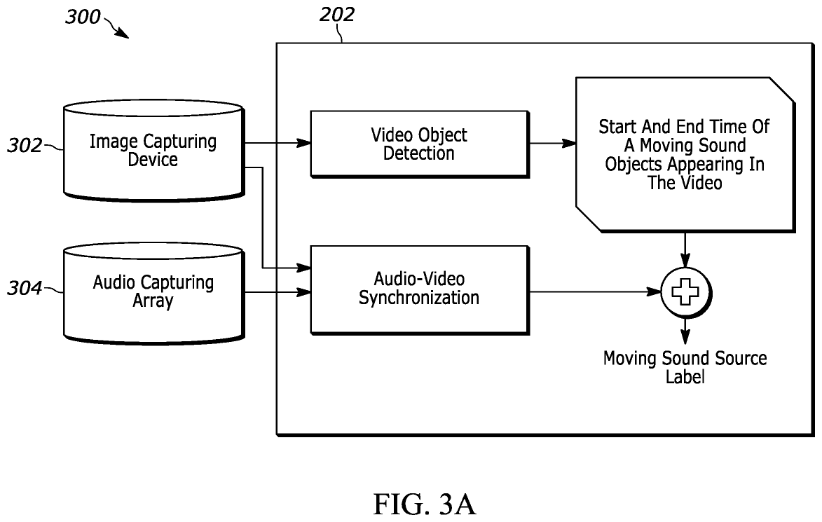

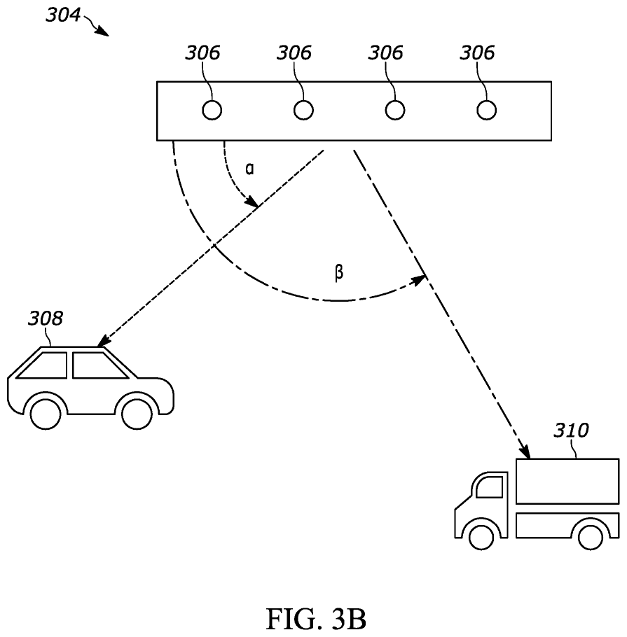

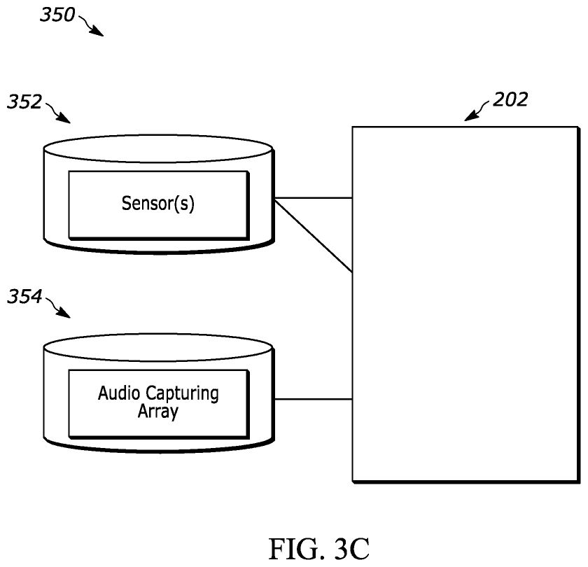

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

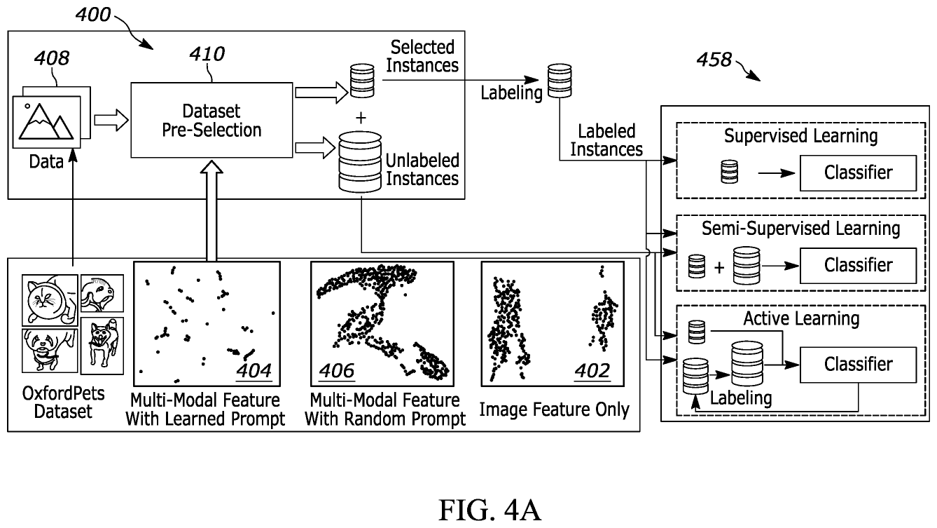

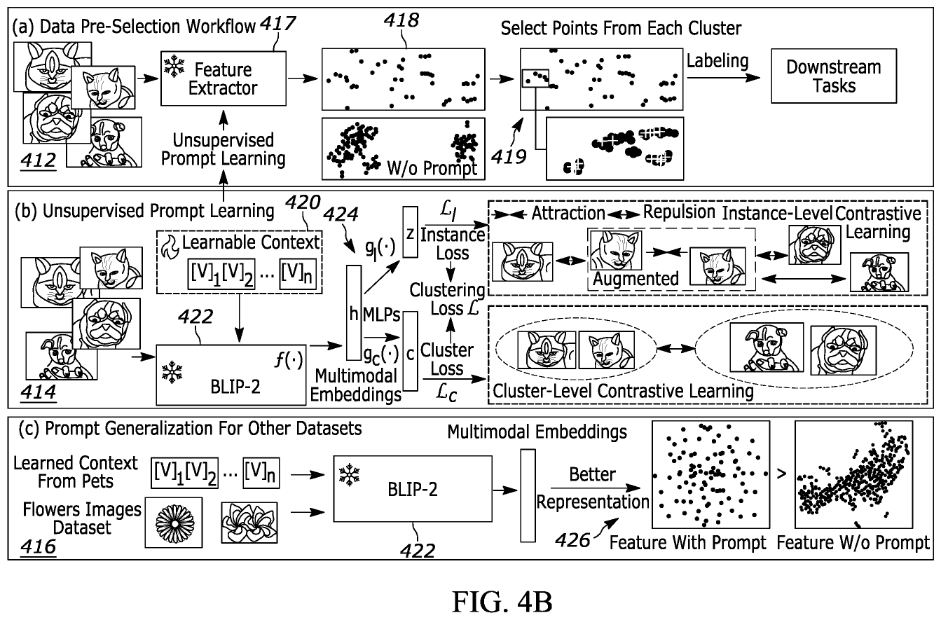

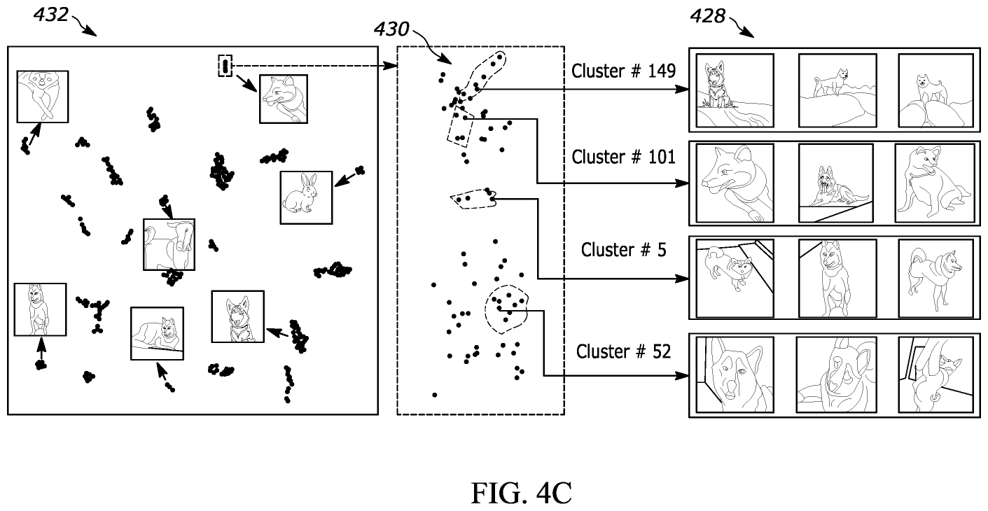

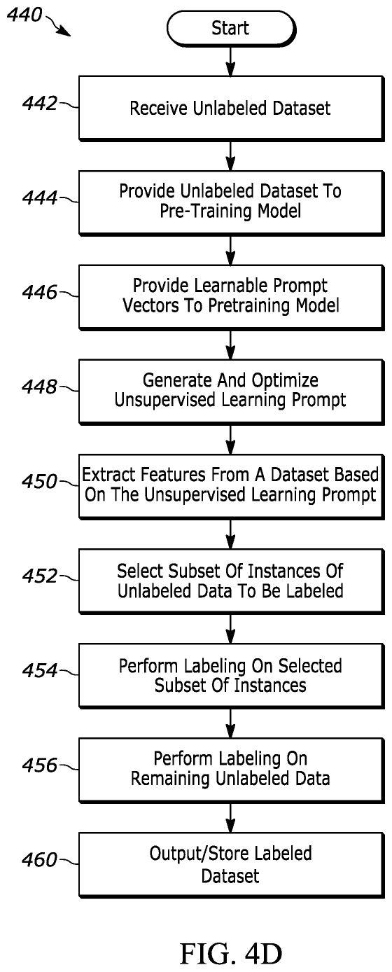

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

Any of the systems described above and/or below in more detail may implement the data pre-selection systems and methods of the present disclosure, including unsupervised prompt learning techniques in a vision-language model for data pre-selection.

FIG. 4A illustrates an example data pre-selection system 400 according to the present disclosure. Example unimodal and multi-modal feature representations obtained from an example V-L pre-training model (e.g. a BLIP-2 model) for various ground truth labels are shown at 402 (e.g., a unimodal feature representation using only a vision/image feature) and 404 (e.g., a multi-model feature representation using a learned prompt) as U-map visualizations. For comparison, results using a random prompt are shown at 406. Notably, when class information of downstream tasks is unknown, the unimodal features become mixed as shown at 402, making it challenging to identify specific classes. In contrast, when coupled with an appropriate prompt, the multi-modal features exhibit a more scattered and distinct distribution as shown at 404, thereby enabling improved discrimination among classes. Accordingly, as shown at 404, a V-L model with an appropriate prompt can provide visually superior multi-modal features compared to unimodal features as shown at 402, which can serve as an effective starting point for data pre-selection. This enhanced discrimination is crucial in helping users identify the most representative and diverse instances during the data pre-selection process.

The goal of data pre-selection is to select instances for labeling from an unlabeled dataset 408 (e.g., an OxfordPets training dataset) through a single pass to maximize model performance for unknown downstream vision tasks (i.e., without knowledge of prediction categories) given a limited annotation budget. This task is motivated by two practical needs: (i) at the data acquisition stage, it is desirable to collect a minimal amount of data to support potentially diverse downstream tasks (e.g., classification, action recognition, detection for videos or images, etc.) and training paradigms (e.g. active learning, semi-supervised learning, supervised learning, etc.); and (ii) at the annotation stage, we aim to achieve a desired level of performance with fewer human annotations over the pre-selected data.

As shown in FIG. 4A, the unlabeled dataset 408 is provided to a dataset pre-selection module or circuitry 410 configured to perform data pre-selection for a data efficiency learning task as described below in more detail. The data efficiency learning task according to the present disclosure incorporates multi-modal features using a learned prompt and differs from semi-supervised learning and active learning tasks and does not require seed labels and downstream task information.

Data pre-selection according to systems and methods of the present disclosure is described in more detail in FIG. 4B, with continued reference to FIG. 4A. The systems and methods are configured to formally define a data pre-selection task, provide an unsupervised prompt learning framework to assist a pre-training (e.g., BLIP-2) model in extracting improved multimodal features for data pre-selection, and use the adapted BLIP-2 model to select instances for downstream tasks. Workflow for data pre-selection, a training process for unsupervised prompt learning, and generalization of learned prompts across various datasets are shown at 412, 414, and 416, respectively.

For data pre-selection, a very large dataset D consisting of d instances and an annotation budget of l is assumed for illustration purposes. The task is to select l (l«D) instances for labeling so that undefined downstream tasks trained on such a partially labeled dataset produce the best performance. Formally, D=(xᵢ,yᵢ)ᵢ₌₁^{d} denotes d pairs of images xᵢ and a corresponding class label yᵢ (yᵢ=Ø if label is unknown). D_{L} denotes a size l subset of D with known class labels. The goal is to select D_{L}⊂D for acquiring class labels to maximize the performance of an undefined model trained on labeled data D_{L} with or without unlabeled data D_{U}=D\D_{L}. This data pre-selection task is challenging due to the absence of any labels to begin with. In other words, the information that will maximize the performance of the undefined downstream task perform is unknown. Accordingly, the goal is to select l instances that are not only representative but also diverse enough to broadly cover the entire dataset, preventing premature loss of valuable information prior to label acquisition.

As shown at 412, the data pre-selection includes extracting semantically significant and high-quality features from a dataset (e.g., using a feature extractor module or circuitry 417) based on an unsupervised learning prompt. For example, the feature extractor module 417 may be implemented by circuitry such as the dataset pre-selection module 410. In some examples, the dataset pre-selection module 410 implements one or more components configured to perform functions of the unsupervised prompt learning shown at 414. The extracted features facilitate the clustering of all unlabeled images into well-structured groups as shown at 418 (relative to feature clustering without the prompt). Subsequently, a medoid point is selected from each cluster to serve as the representative image for labeling as shown at 419. The utilization of medoids achieves representativeness while selecting one instance from each cluster achieves diversity. The BLIP-2 model according to the present disclosure is adapted accordingly as described below in more detail.

As shown at 414, unsupervised prompt learning according the present disclosure is configured to extract desirable features from the data set using a learnable context 420 of a BLIP-2 model 422 and two Multilayer Perceptron (MLP) heads for both instance-level and cluster-level transformation. These components are jointly optimized using unsupervised clustering objectives (specifically, instance-level and cluster-level contrastive learning). After training, the cluster assignments of all instances can be easily derived from the predicted soft labels produced by the cluster-level MLP head. When combined with the multimodal features obtained from the adapted BLIP-2 model, the most representative and diverse instances from the entire dataset D can be effectively identified.

The BLIP-2 model 422 provides an efficient pre-training strategy that leverages existing pre-trained image encoders and large language models, all while parameters of the BLIP-2 model remain frozen. Training a lightweight querying transformer (Q-Former) bridges the modality gap between images and text. In the representation learning phase, the BLIP-2 model 422 connects the Q-Former to a frozen image encoder and conducts image-text pair pre-training. With three Image-Text pre-training objectives (Image-Text Contrastive Learning, Image-grounded Text Generation, and Image-Text Matching), a strong connection between image and input text is established (i.e., the BLIP-2 model 422 is forced to extract visual information from the image that is most relevant to the text and automatically generate output multimodal features). This characteristic of the BLIP-2 model 422 provides an opportunity to alter different prompts (e.g., input text), extract distinct multimodal features, and enhance the process of data pre-selection.

However, selecting an appropriate prompt can be demanding and time-consuming, especially for data pre-selection, when downstream tasks are unknown. Following the previous prompt learning approach, each context token can be modeled using a continuous vector that can be end-to-end learned from data. Specifically, as shown at 414, N learnable prompt representation context vectors are defined, denoted as V=v₁, v₂, . . . vₙ, each having the same dimension as the word embedding, to serve as the text input for the BLIP-2 model 422. In contrast to many previous methodologies that leverage cross-entropy loss as their learning objective with label data, the systems and methods described herein implement unsupervised clustering as a learning objective with respect to undefined downstream tasks. Since the text encoder is differentiable, gradients can be back-propagated to update the context vectors. The base model of the BLIP-2 model 422 remains unchanged during the training process.

The output of the BLIP-2 model 422 may be affected by both instance-level contrastive loss (“instance loss”) and cluster-level contrastive loss (“cluster loss”). With respect to instance loss, contrastive learning at the instance level is designed to maximize the similarities between positive instance pairs, while simultaneously minimizing similarities of negative pairs. Given the lack of labels for all the data, the goal is to maximize the agreement between differently augmented views of the same instance and treat all other augmented instances as negative examples. Specifically, a randomly sampled mini-batch of image of N images is considered. Each image, denoted by xᵢ, undergoes different augmentation twice, thus creating two views of the same example: xᵢ^{a} and xᵢ^{b}. These two images are subsequently encoded, along with a learnable context V, in accordance with f(·) of the BLIP-2 model 422, to generate multimodal representations: hᵢ^{a} and hᵢ^{b}. Following this, the representations are further transformed via a non-linear transformation MLP gₗ(·) as shown at 424, known as an instance-level head, which yields zᵢ^{a} and zᵢ^{b}. Here, sim(·,·) denotes the cosine similarity. Then the instance-level contrastive loss of a positive pair of examples (i,j)∈[1,N] is defined as

$${l}_{i}^{a} = - log \frac{exp ( sim ( {z}_{i}^{a} , {z}_{i}^{b} ) / {τ}_{I} )}{{\sum }_{k ∈ \{ a , b \}} {\sum }_{j = 1}^{N} exp ( sim ( {z}_{i}^{a} , {z}_{j}^{k} ) / {τ}_{I} )} ,$$

where τ_{I} is the temperature scalar. The final loss corresponds to

$${ℒ}_{I} = \frac{1}{2 N} {\sum }_{i}^{N} ( {l}_{i}^{a} + {l}_{i}^{b} ) ,$$

which is computed across all positive pairs in a mini-batch.

Similar to instance-level contrastive learning, the cluster-level contrastive learning aims to maximize the similarities between positive cluster pairs while minimizing the negative pairs. To construct cluster representation, another cluster-level head g_{C}(·) is used to map the multimodal representations to a M-dimensional space, where M equals the number of clusters. Thus, an m-th element of the feature can be interpreted as a probability of an instance belonging to the m-th cluster. With a mini-batch of N samples and M predefined clusters, the output of the cluster head is C^{a}∈R^{N×M} under the first augmentation and C_{n,m}^{a} can thus be interpreted as the probability of sample $n$ under augmentation $a$ being assigned to the cluster m. The i-th column of C^{a} can be treated as the representation of an i-th cluster under augmentation a. Thus, a positive pair of clusters can by formed by selecting i-th column of C^{a} and C^{b} noted as ĉᵢ^{a} and ĉᵢ^{b} while leaving other 2M−2 pair to be negative as shown below:

$$= - log \frac{exp ( ( {\hat{c}}_{i}^{a} , {\hat{c}}_{i}^{b} ) / {τ}_{C} )}{{\sum }_{k ∈ \{ a , b \}} {\sum }_{j = 1}^{N} exp ( ( {\hat{c}}_{i}^{a} , {\hat{c}}_{i}^{k} ) / {τ}_{C} )} ,$$

where τ_{C} is the cluster-level temperature parameter. To avoid a trivial solution where most instances are assigned to the same cluster, a regularization that encourages the entropy of cluster assignment probability is added as shown below:

$$H ( C ) = - {\sum }_{i}^{M} [ P ( {\hat{c}}_{i}^{a} ) log P ( {\hat{c}}_{i}^{a} ) + P ( {\hat{c}}_{i}^{b} ) log P ( {\hat{c}}_{i}^{b} ) ] ,$$

where

$$P ( {\hat{c}}_{i}^{k} ) = \frac{1}{N} {\sum }_{t = 1}^{N} {\hat{C}}_{ti}^{k} , k ∈ \{ a , b \} .$$

The final cluster-level loss is

$${ℒ}_{C} = \frac{1}{2 M} {\sum }_{i = 1}^{M} ( + ) - H ( C ) .$$

In this manner, as described above and shown in FIG. 4B, optimizing the training of the BLIP-2 model 422 is a one-stage and end-to-end process. The prompt and two heads are simultaneously optimized, and the overall objective function is the combination of both instance-level and cluster-level contrastive loss (e.g., [symbol] = [symbol] _{I}+ [symbol] _{C}).

After training, each instance is assigned a cluster number by the adapted BLIP-2 model 422 and cluster-level MLP head, resulting in several sampling strategies. First, a probability predicted by the Cluster-level head g_{C}(·) is used for sampling. In this case, for each cluster, the instance with the highest confidence score is selected. Conversely, the medoid of each cluster can be selected to be labeled for the downstream task. Given the cluster Xₖ with Nₖ members {x₁, x₂ . . . x_{N}_{ₖ}}, the medoid mx is the instance that has the minimal average dissimilarity to all instances calculated on the multi-modal feature h, or the form f(·) or project feature z for g_{I}(·).

As shown at 416, the learned prompts obtained at 412 and 414 can be generalized across various datasets. For example, although the learned prompts (N learnable prompt representation context vectors V) were obtained from a dataset of pets, these same prompts can be used for dataset pre-selection for a different dataset (e.g., a flower images dataset). As shown at 426, providing the learned prompts obtained based on the pets dataset to the BLIP-2 model 422 results in improved clustering of features detected in the flower images dataset.

FIG. 4C generally illustrates results of the unsupervised prompt learning for data pre-selection (UP-DP) systems and methods of the present disclosure for downstream tasks, specifically using selected labeled instances for image classification. For example, FIG. 4C illustrates an intuitive understanding of the functioning of UP-DP systems and methods by visualizing the learned feature representation and cluster assignment of all instances using 2D projection with Uniform Manifold Approximation and Projection (UMAP). The features extracted using the BLIP-2 model 422 with learned prompts demonstrate discriminative abilities to distinguish between different types of dogs and cats. For example, for a Shiba Inu group 428, cluster assignments generated by our cluster-head categorize Shiba Inus into distinct clusters based on background and posture as shown at 430. The multi-modal feature is extracted using the BLIP-2 model 422 with learned prompts. The features extracted with the learned prompts can distinguish between various types of pets even without the labels as shown at 432. In other words, the extracted features capture more detailed information, such as background, pet postures, etc., within the same breed or animal type. Accordingly, as shown in FIG. 4C, UP-DP systems and methods effectively select diverse representative points from unlabeled image data.

In this manner, as described herein, a learned prompt obtained using a dataset can be used across different other datasets, which significantly enhances feature extraction when applied in a plug-and-play manner.

FIG. 4D illustrates steps of an example data pre-selection method 440 according to the principles of the present disclosure. For example, one or more processors or processing devices are configured to execute instructions to implement the method 440, such as one or more of the processors of the systems described herein. At 442, the method 440 receives an unlabeled dataset. At 444, the unlabeled dataset is provided to a pre-training model (e.g., a BLIP-2 model as described above). At 446, a plurality of learnable prompt vectors (e.g., vectors V as defined above) are provided to the pre-training model (e.g., as text inputs to the BLIP-2 model).

At 448, the method 440 (e.g., the pre-training model) generates and optimizes, based on the unlabeled dataset and the learnable prompt vectors, an unsupervised learning prompt corresponding to a multi-modal feature. The unsupervised learning prompt represents an optimization of the learnable prompt vectors. At 450, the method 440 (e.g., the feature extractor module 417) extracts features from a dataset (e.g., a same or different dataset as the dataset provided to the pre-training model) based on the unsupervised learning prompt. For example, the extracted features correspond to clusters of unlabeled image data (e.g., unlabeled images) as shown at 418. At 452, the method 440 selects a subset of instances (“selected instances”) of the unlabeled data to be labeled. In this manner, the most valuable features for labeling are selected from the unlabeled data.

At 454, labeling is performed on the selected subset of instances. At 456, labeling is performed on remaining unlabeled image data (i.e., instances not labeled at 454) based on the labeled selected subset of instances. For example, the labeling performed at 456 may include using one or more classifiers (e.g., as shown at 458 in FIG. 4A) and may be implemented using supervised learning, semi-supervised learning, active learning, or combinations thereof. At 460, the method 440 outputs and/or stores a labeled dataset.

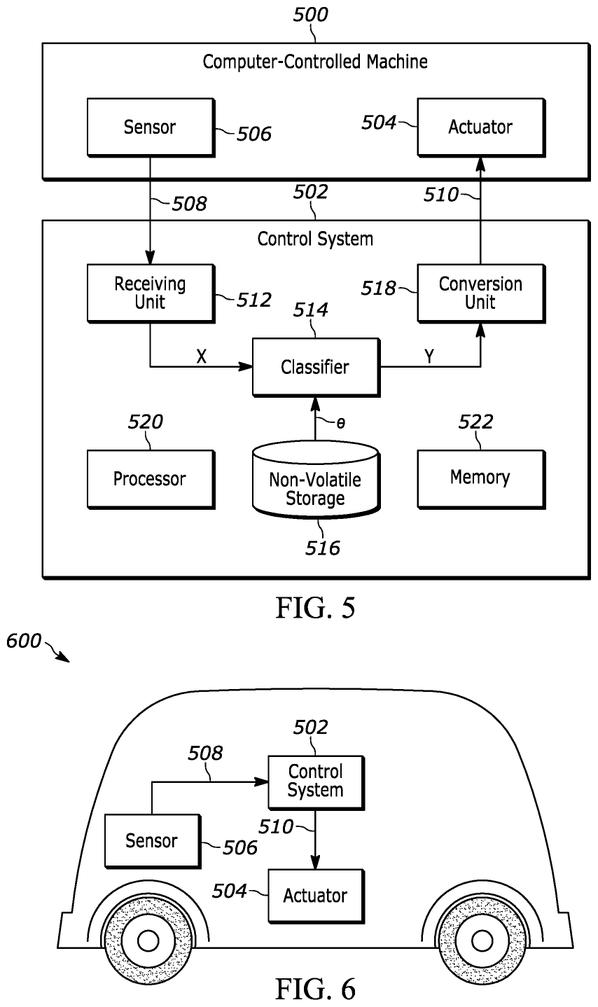

FIGS. 5-11 depict example systems and devices that may implement UP-DP systems and methods according to the present disclosure. FIG. 5 depicts a schematic diagram of an interaction between a computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to produce each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network. For example, the classifier 514 corresponds to the classifier 408 described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more anomaly detection methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the anomaly detection methodologies as disclosed herein. Non-volatile storage 516 may also include data supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

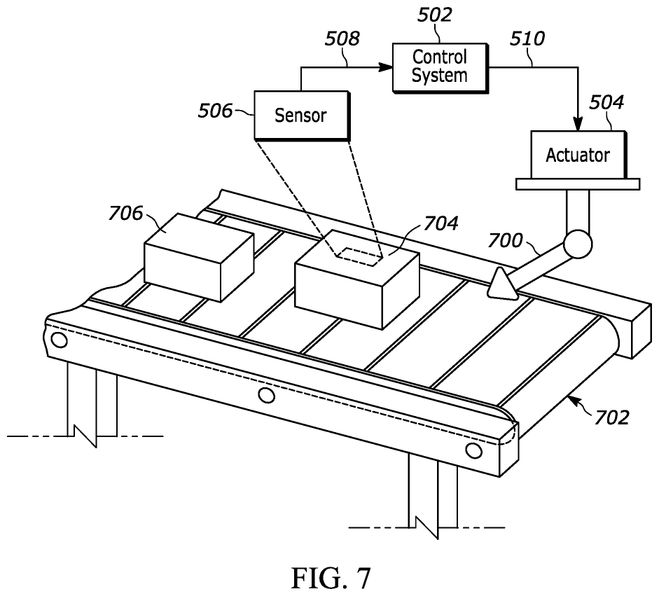

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

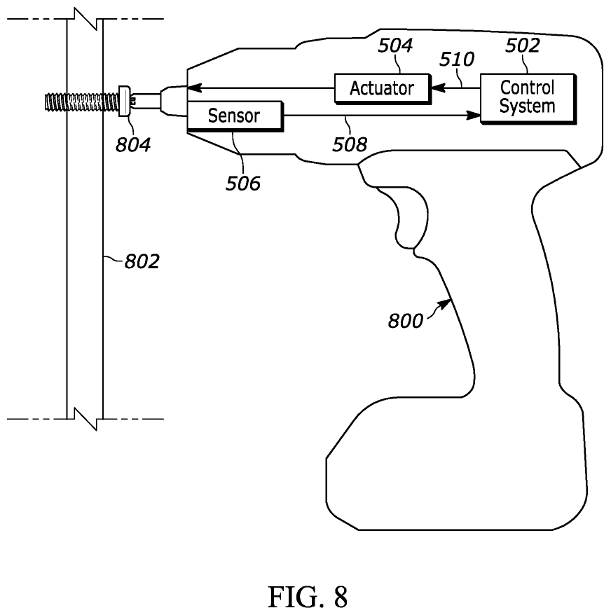

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

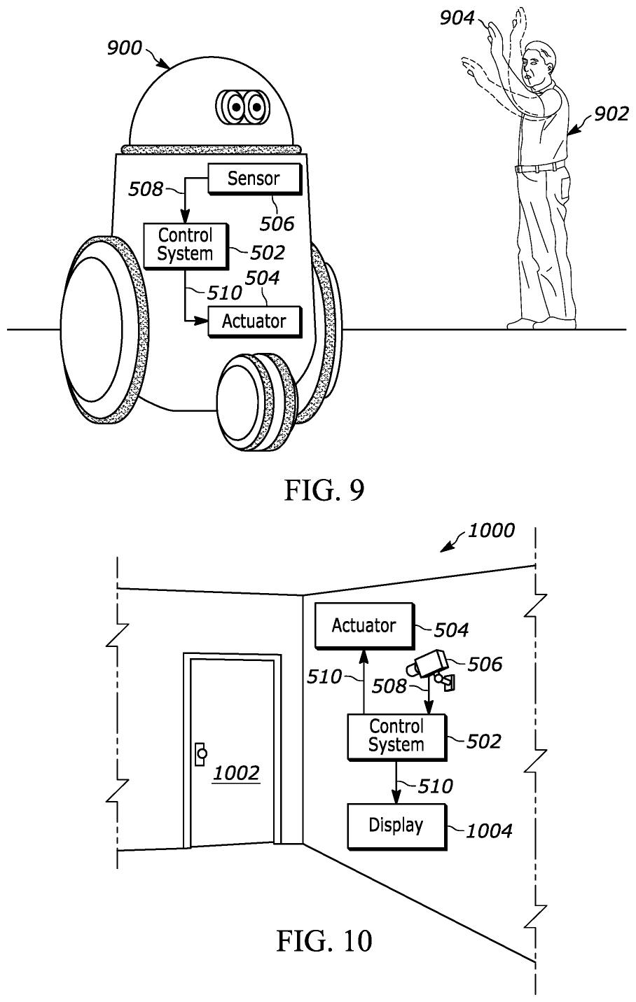

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

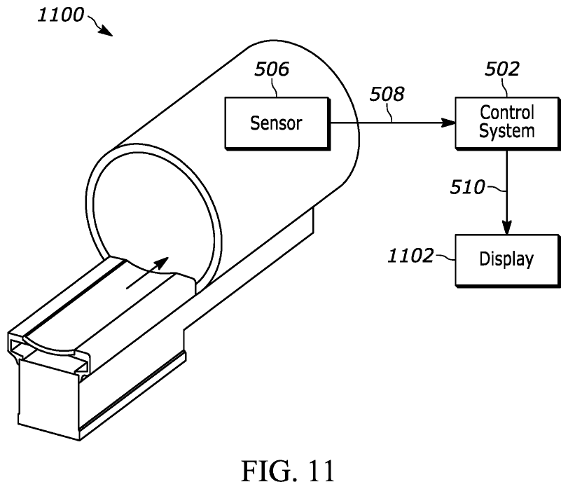

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of performing data pre-selection for an object detection system, the method comprising:
receiving a first dataset, wherein the first dataset includes unlabeled data corresponding to one or more images;
providing the first dataset and a plurality of learnable prompt vectors to a pre-training model, wherein the learnable prompt vectors include text inputs;
generating, using the pre-training model, an unsupervised learning prompt based on the first dataset and the plurality of learnable prompt vectors, wherein the unsupervised learning prompt corresponds to a multi-modal feature of the one or more images of the first dataset;
extracting features from either of the first dataset and a second dataset based on the unsupervised learning prompt;
selecting and labeling a subset of instances of the extracted features; and
generating and outputting a labeled dataset based on the labeled subset of instances.

2. The method of claim 1, wherein the pre-training model is a Bootstrapping Language-Image Pre-training (BLIP-2) model.

3. The method of claim 1, wherein the extracted features include clusters of unlabeled image data.

4. The method of claim 3, wherein the selected subset of instances includes one or more of the clusters of unlabeled data.

5. The method of claim 4, further comprising selecting a representative image for labeling from each of the clusters of unlabeled image data.

6. The method of claim 5, wherein selecting the representative image includes selecting the representative image based on a medoid of a corresponding one of the clusters of unlabeled image data.

7. The method of claim 1, wherein generating the unsupervised learning prompt includes calculating instance-level contrastive loss and cluster-level contrastive loss.

8. A computing device configured to perform data pre-selection for an object detection system, the computing device including a processing device configured to execute instructions stored in memory to:
receive a first dataset, wherein the first dataset includes unlabeled data corresponding to one or more images;
provide the first dataset and a plurality of learnable prompt vectors to a pre-training model, wherein the learnable prompt vectors include text inputs;
generate, using the pre-training model, an unsupervised learning prompt based on the first dataset and the plurality of learnable prompt vectors, wherein the unsupervised learning prompt corresponds to a multi-modal feature of the one or more images of the first dataset;
extract features from either of the first dataset and a second dataset based on the unsupervised learning prompt;
select and label a subset of instances of the extracted features; and
generate and output a labeled dataset based on the labeled subset of instances.

9. The computing device of claim 8, wherein the pre-training model is a Bootstrapping Language-Image Pre-training (BLIP-2) model.

10. The computing device of claim 8, wherein the extracted features include clusters of unlabeled image data.

11. The computing device of claim 10, wherein the selected subset of instances includes one or more of the clusters of unlabeled data.

12. The computing device of claim 8, wherein the processing device is configured to execute instructions to select a representative image for labeling from each of the clusters of unlabeled image data.

13. The computing device of claim 12, wherein the processing device is configured to execute instructions to select the representative image based on a medoid of a corresponding one of the clusters of unlabeled image data.

14. The computing device of claim 8, wherein the processing device is configured to execute instructions to calculate instance-level contrastive loss and cluster-level contrastive loss.

15. A computer-controlled machine, comprising:
at least one sensor configured to generate an input image;
a control system configured to perform data pre-selection for an object detection system, the control system configured to
receive a first dataset, wherein the first dataset includes unlabeled data corresponding to one or more images,
provide the first dataset and a plurality of learnable prompt vectors to a pre-training model, wherein the learnable prompt vectors include text inputs,
generate, using the pre-training model, an unsupervised learning prompt based on the first dataset and the plurality of learnable prompt vectors, wherein the unsupervised learning prompt corresponds to a multi-modal feature of the one or more images of the first dataset,
extract features from either of the first dataset and a second dataset based on the unsupervised learning prompt,
select and label a subset of instances of the extracted features, and
generate and output a labeled dataset based on the labeled subset of instances; and
an actuator configured to control an operation of the computer-controlled machine based on the labeled dataset.

16. The computer-controlled machine of claim 15, wherein, the pre-training model is a Bootstrapping Language-Image Pre-training (BLIP-2) model.

17. The computer-controlled machine of claim 15, wherein the extracted features include clusters of unlabeled image data, and wherein the selected subset of instances includes one or more of the clusters of unlabeled data.

18. The computer-controlled machine of claim 15, wherein the control system is configured to select a representative image for labeling from each of the clusters of unlabeled image data.

19. The computer-controlled machine of claim 18, wherein the control system is configured to select the representative image based on a medoid of a corresponding one of the clusters of unlabeled image data.

20. The computer-controlled machine of claim 15, wherein the control system is configured to calculate instance-level contrastive loss and cluster-level contrastive loss.
